(19) United States
(12) Patent Application Publication
(10) Pub. No.: US 2006/0202567 A1
(43) Pub. Date: Sep. 14, 2006

(54) Non-rotating linear actuator

(76) Inventor: Rainer Bierlich, Erkrath (DE)

Correspondence Address: Mark J. Pandiscio;Pandiscio & Pandiscio, P.C., 470 Totten Pond Road, Waltham, MA, 02451-1914, US

(21) Appl. No.: 11/359,178

(22) Filed: Feb. 22, 2006

(30) Foreign Application Priority Data
Feb. 24, 2005 (DE) 10 2005 008 812.0

(51) Int. Cl. H02K 41/00

(52) U.S. Cl. 310/12

(57) ABSTRACT

Linear actuator according to the principle of the synchronous motor, wherein the movable part is integrated non-rotatingly at mounting into a system which has to be actuated by the linear actuator by means of its axial movement, wherein the ring permanent magnets (5) are radially magnetized.

For the electric operation of non-rotating rotors, a linear actuator can be used which does not need to rotate.

With regard to the operating force, the operating path, and the supply voltage, an application is possible in various technical problems by means of variation of these linear actuators.

Linear actuators, where the movable part does not have to be rotating for the operation of the rotor are e.g. needed for the rotation of rotors, if between the rotation rotor and the linear actuator an axially operating bearing for a rolling element is present.

By this means, the rotation movement of the rotating rotor is coupled from the non co-rotating connecting rod or something similar of the linear actuator.

However, if a high operating force is required, linear actuators are used where the construction is entirely rotationally symmetrical.

These motors are realized after a synchronous-like principle. The movable part is air-core and consists of ring permanent magnets which are axially magnetized. The static part is composed of a solenoid coil, which is arranged in a 2- or 3-phase way. The comparatively simple construction is similar to the construction of an electromagnet.

The air-core construction and the nature of the construction result in longer magnetic flux paths due to the air or the magnets themselves, which results in a decrease of the motor efficiency. The fixing of the magnets and the control of the movable part have to consist of non-magnetic material, which increases the costs of the construction. The solenoid coil also has to be fixed by means of a non-magnetic material. This increases the air gap of the motor and also results in an unfavourable ratio of electric power to the required operating force or operating dynamic respectively. Due to the type of these linear actuators, which is similar to an electromagnet, and the high fluctuations of power provoked by this dependent on the respective relative position between rotor and stator, which are similar to the detent torque of a rotating motor, an exact path control or positioning is only possible by means of very exact and therefore very expensive linear transducers. Furthermore, a modular assembling of such a construction regarding operating force or supply voltage would not be realizable, since all other construction characteristics result from the magnet and the coil measurements.

Altogether, this is a simple but relatively expensive construction with a considerable decrease of the possible efficiency and very restricted possibilities for modular assembling.

Object of this invention is therefore the construction of a non-rotating actuator which has to be operated linearly, which reliably avoids the above-mentioned disadvantages.

Thereby, the rectifier inverter capacity which has to be at disposal in relation to operating force, holding force and dynamic should be realized as ideally as possible by means of a high efficiency, so that overall, this results in an economical construction on the basis of which a modular construction system can be developed.

This object is solved by the characteristics of the main claim.

It is essential that the movable part consists of ring permanent magnets, which are radially magnetized although they are not meant to rotate during operation.

Favourably, it concerns a construction based on the principle of the linear motor according to the synchronous principle, next to whose permanent magnets perpendicularly to the moving direction, an at least predominant rotational symmetry of the magnetized condition is produced.

Favourably, a magnetic carrier in the form of a tube is used for this, which carries the magnets mechanically and can conduct the magnetic flux.

The stator of the linear actuator consists of several individual concentrated coils, which are to be allocated steadily and arranged radially. These coils are also mechanically held by a magnetic carrier in form of a tube, which also conducts the magnetic flux and can be used as body.

The magnetic cores of the coils of each individual phase can be linked by means of a magnetic ring which provides an optimized conduction of the magnetic flux.

The number of the different phases of the electric system results in radial levels which are arranged axially successive.

The basic segment of the actuator which originated from this, consisting of the rings with the concentrated coils and the corresponding movable part, can be arranged axially successive both in the moving part and in the static part of the linear actuator, to vary the operating path and/or the operating force. Various circuits of individual concentrated coils allow an operation with varying operating voltages.

Thereby the moving part, which consists of radially magnetized ring magnets and a magnetic carrier tube, is easy to construct and therefore economical.

As a consequence of the construction it is possible to use magnet rings with varying height and length with spacers, which easily results in a modularity according to the operating force although the construction basically remains the same. The individual coils of each phase of the static part can be circuited in different ways, so that different supply voltages can be realized without a decrease in capacity. For conducting the magnetic flux, balancing magnets are used which warrant an optimal coupling of movable and static part. The short paths of the magnetic flux in the air and in the magnets originating from this result in a particularly high efficiency.

A basic segment of the actuator consists of e.g. a 3-phase electric system of three rings with the concentrated coils and the corresponding permanent magnets. These segments can also be arranged axially successive, resulting in a modularity of the operating path and/or the operating force.

This construction is ideally applicable for the realization of a modular construction system, since the expensive components e.g. magnet rings and coils can be used in all types alike and therefore, there is still economization potential for linear actuators with high operating forces.

Only the more economical components such as e.g. the carrier tubes are specific to the different types.

In the following, the invention will be further elucidated by means of a type example:

The following is shown:

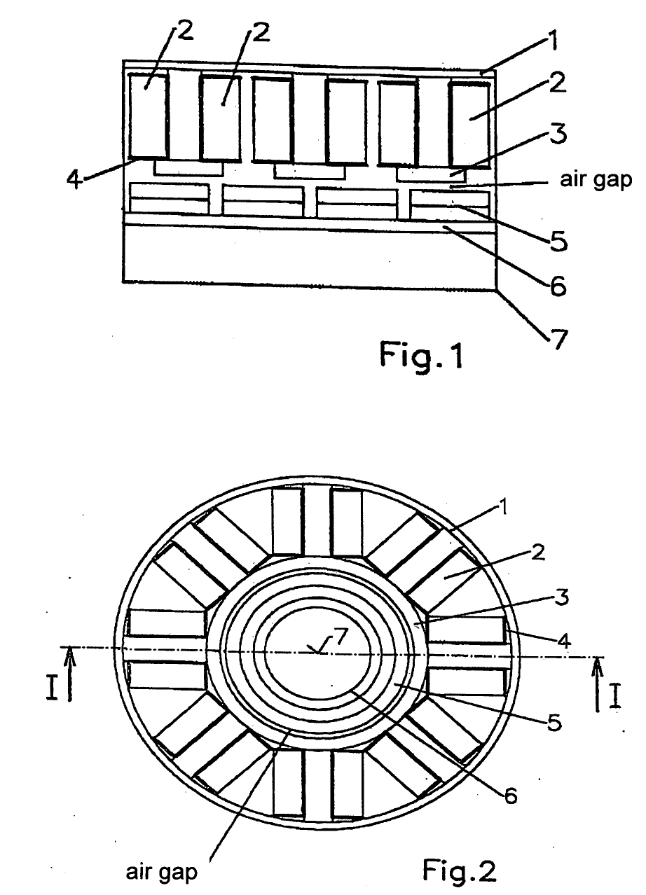

FIG. 1 an axial section through a 3-phase segment of the actuator; and

FIG. 2 a radial section through a type example according to FIG. 1

Provided that in the following nothing else is stated, the following description applies to all figures alike.

The figures show a linear actuator according to the present invention.

The dashed curve 7 is meant to be the axis around which the linear actuator is rotationally symmetrical.

Such a linear actuator consists of three concentrated coils 2, which are held by plastic winding forms 4. The magnetic material of the static part 1 conducts the magnetic flux and balances it by means of the magnet rings 3 against the magnets.

In the movable part, four permanent magnets 5 are arranged which are fixed to the magnetic tube 5, which is the inner carrier tube.

Space, number of and power of the magnetization can be easily varied by means of a different arrangement of thin magnet rings and rings of non-magnetic material.

FIG. 2 is a radial section through the actuator, which lies exactly in a winding level. The outer ring 1 is accomplished as a continuous tube and constitutes the body of the actuator. Eight coils 2 are shown which are arranged regularly on this level. By means of different circuits, four different operating voltages can be realized. The inner rings 3 have a similar function as pole shoes. They make sure that the magnetic flux permeates the magnets 5 as homogenously and radially as possible. Magnets 5 are ring magnets.

Between the outer perimeter of ring magnet 5 and the inner perimeter of the inner ring 3 lies a not further specified air gap which can be of a very minor size.

By means of the construction shown, it is additionally possible to accomplish the pole numbers of the static and the movable part differently. In this case, a segment consists of three coil rings, according to the number of phases. Opposite to this, four permanent magnets are arranged, which results in a considerable homogenizing of the power, related to the axial position of the movable part.

Therefore, a sensor-less regulation of the axial position of the actuator is possible depending on the required accuracy.

Overall, this construction offers all required qualities concerning the modularity of operation path, operation force and supply voltage and can be produced economically due to the high efficiency and the effective material utilization.

Furthermore, it has the advantage of a sensor-less regulation of the axial position.

All qualities added make an optimised modular system for the operation of non-rotating rotors possible, as long as the rotation movement of the rotor is not decoupled from the non-rotating part of the linear actuator by means of an axial bearing.

### REFERENCE NUMERAL LIST

1 static part
2 coil
3 ring
4 plastic winding form
5 ring permanent magnet
6 magnetic tube
7 rotationally symmetrical axis

1. Linear actuator assembly according to the principle of a synchronous motor, wherein a movable part is integrated non-rotatingly in a system which is actuated by a linear actuator by means of axial movement thereof, and wherein ring permanent magnets (5) are radially magnetized.

2. Linear actuator assembly according to claim 1, wherein stator coils (2) of individual phases comprise individual, concentrated windings.

3. Linear actuator assembly according to claim 2, wherein for each of said phases, rings (3) consisting of magnetic material are adapted to homogenize magnetic flux in an air gap.

4. Linear actuator assembly according to claim 3, wherein the axially movable part of the linear actuator assembly is linked to a force transducer which rotates during operation by means of an axial bearing, and wherein the rotational movement of the force transducer is adapted to be decoupled from the non-rotating movable part of the linear actuator assembly by an axial bearing.
